(19) United States
(12) Patent Application Publication
(10) Pub. No.: US 2004/0150606 A1
(43) Pub. Date: Aug. 5, 2004

(54) Temperature compensation mechanism for LCD module in a time of flight ranging system

(75) Inventor: Nigel Ashley Preston, Peterborough (CA)

Correspondence Address: MERCHANT & GOULD PC, P.O. BOX 2903, MINNEAPOLIS, MN, 55402-0903, US

(73) Assignee: Siemens Milltronics Process Instruments Inc., Peterborough (CA)

(21) Appl. No.: 10/703,838

(22) Filed: Nov. 6, 2003

(30) Foreign Application Priority Data
Jan. 31, 2003 (CA) 2,418,156

(51) Int. Cl. G09G 3/36

(52) U.S. Cl. 345/100

(57) ABSTRACT

A temperature compensation circuit for a liquid crystal display (LCD) module. The temperature compensation circuit includes a thermistor which in response to changes in temperatures changes the clocking rate for the drive signals for the LCD module. A further bias voltage circuit may be included which in response to a change in temperature changes the bias voltage for the LCD module. The effect of the temperature variable clocking rate and/or bias voltage is to improve the segment contrast and therefore the definition of information displayed on the LCD module. The temperature compensation circuit is particularly suited for LCD modules used in level measurement systems installed in harsh industrial or outdoor environments.

### FIELD OF THE INVENTION

The present invention relates to liquid crystal display (LCD) modules, and more particularly to a temperature compensation mechanism for a LCD module suitable for use in time of flight ranging and level measurement systems.

### BACKGROUND OF THE INVENTION

Time of flight ranging systems are commonly used in level measurement applications, and as such are referred to as level measurement systems. Level measurement systems determine the distance to a reflector (i.e. reflective surface) by measuring how long after transmission of a burst of energy pulses, an echo is received. Such systems typically utilize ultrasonic pulses, pulse radar signals, or microwave energy signals. Such systems often operate in environments that are exposed to the elements, for example, in the outdoors, or in harsh industrial environments.

Level measurement systems typically include a LCD matrix display. The LCD provides a display panel for showing operational parameters and may also be used for programming the device.

The operating environment for the level measurement and/or time of flight ranging systems places certain operational constraints on the LCD matrix display. Level measurement systems are typically expected to operate over a wide temperature range, for example, −40 to +85 Centigrade. As temperature varies on a Liquid Crystal Display (LCD) matrix, the properties of the display itself change in such a way as to effect readability.

For non-multiplexed displays, this is generally not a major issue. Non-multiplexed displays have a single back plane, and each segment can be driven with an AC (alternating cycle) waveform to turn the segment dark, or with no signal to leave the segment transparent.

For multiplexed displays, maintaining correct contrast is more difficult. Multiplexed displays contain several back planes, and the waveforms on the back planes and the segments become complex. Rather than being on (having an AC waveform present) or off (no voltage), each segment sees a composite signal that can range anywhere from zero voltage to a full voltage level. The contrast ratio of a segment is defined as the ratio between the voltage present when the segment is considered off, versus the voltage present when the segment is considered turned on.

As temperature is varied, the LCD matrix reacts differently in the presence of the backplane and segment drive waveforms. Typically, the segments become less visible as the temperature is lowered, that is, they tend to appear to be off. As temperature is increased, the segments that should be off tend to become visible.

One common way of compensation for this variance over temperature is to change the bias voltage under which the LCD matrix operates. This has the effect of increasing all voltages on the LCD matrix display at cold temperatures, and decreasing the voltages at warm temperatures.

This technique works well for non-multiplexed, and low multiplexed displays as they have better segment-to-segment contrast characteristics than LCD displays with higher multiplex rates. However, this technique is not very effective for LCD matrix displays with higher multiplex rates, which includes LCD displays with eight or more back planes.

For multiplexed LCD matrix displays to operate correctly, a fairly high clock rate is needed to modulate the waveforms sent to the LCD. The modulation frequency must be high enough that the display does not appear to flicker.

Accordingly, there remains a need to address the shortcomings associated with higher rate multiplexed LCD matrixes or displays operating over fluctuating temperature ranges.

### BRIEF SUMMARY OF THE INVENTION

The present invention provides a temperature compensation mechanism for a liquid crystal display (LCD). The temperature compensation mechanism is suitable for use with LCD matrixes operating under low temperatures.

In a first aspect, the present invention comprises a temperature compensation circuit coupled to a LCD driver module. The temperature compensation circuit is responsive to drop in the temperature for the operating environment, and lowers the clock rate for the LCD driver module.

In a second aspect, the present invention includes a bias voltage circuit with the temperature compensation circuit. The bias voltage circuit functions to increase the bias voltage for the LCD driver module as the temperature drops.

According to one aspect, the present invention provides a compensation circuit for a liquid crystal display module, the compensation circuit comprises: (a) a compensation component sensitive to temperature change; (b) the liquid crystal display module includes a clocking circuit, the clocking circuit provides clocking signals for activating segments in the liquid crystal display module, and the clocking circuit has a control input for setting a clocking rate; (c) the compensation component is coupled to the control input of the liquid crystal display module, and the compensation component varies the clocking rate in response to a change in the temperature.

According to another aspect, the present invention comprises a level measurement system having (a) a transducer for emitting energy pulses and detecting reflected energy pulses; (b) a controller having a component for controlling the transducer and a component for determining a level measurement based on the time of flight of the reflected energy pulse; (c) a power supply input port for receiving power to operate the level measurement device; (d) a liquid crystal display module coupled to said controller, and being responsive to signals from said controller for displaying one or more operating parameters associated with the level measurement device; (e) a temperature compensation circuit coupled to said liquid crystal display module, said temperature compensation circuit varying a clocking signal for said liquid crystal display module in response to a change in temperature.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Reference is next made to the accompanying drawings which shown, by way of example, embodiments of the present invention and in which:

FIG. 1 shows in schematic form a liquid crystal display module and compensation circuit according to the present invention;

FIG. 2 shows in schematic form a liquid crystal display module and compensation circuit according to another embodiment of the present invention;

FIG. 3 shows in diagrammatic form a level measurement system incorporating a liquid crystal display module and compensation circuit according to the present invention;

FIG. 4 shows in diagrammatic form a level measurement system incorporating a liquid crystal display module and compensation circuit according to another embodiment of the present invention; and

FIG. 5 shows in schematic form an implementation for the bias voltage generator of FIG. 2.

### DETAILED DESCRIPTION OF EMBODIMENTS OF THE INVENTION

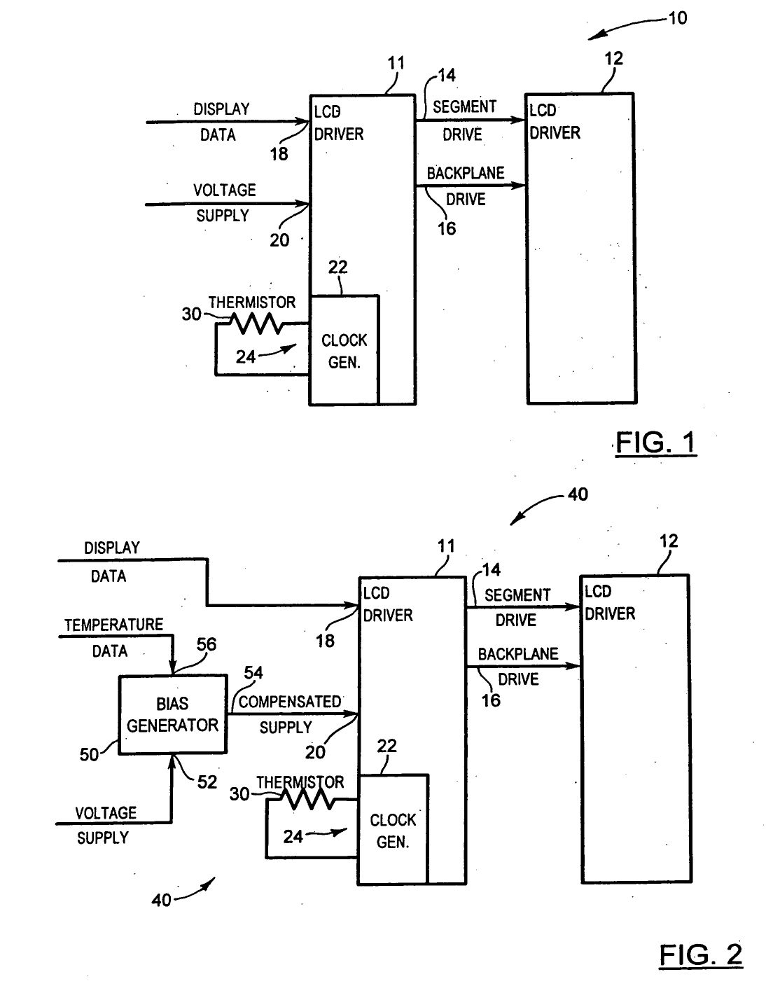

Reference is first made to FIG. 1 which shows a liquid crystal display module according to the present invention and indicated generally by reference 10.

The liquid crystal display module 10 comprises a liquid crystal display (LCD) driver 11 and a liquid crystal display (LCD) matrix 12.

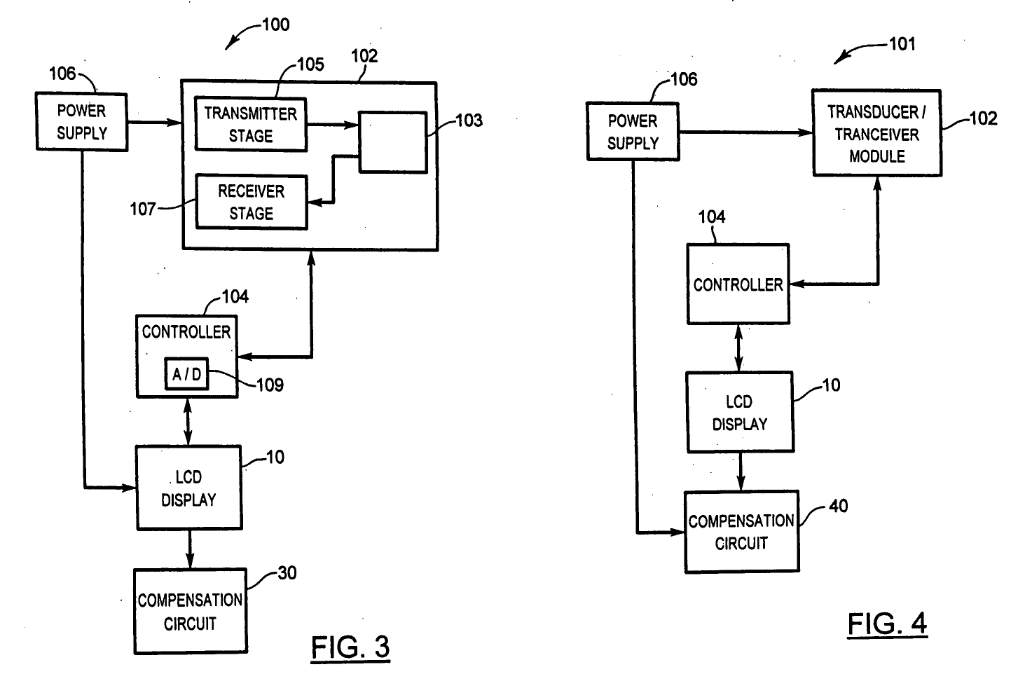

The LCD driver 11 is coupled to the LCD matrix 12 and generates a segment drive signal on output 14 and a backplane drive signal on output 16. The LCD driver 11 includes a data input 18, a supply voltage input 20 and a clock generator circuit 22. The supply voltage input 20 is connected to a power supply (not shown) and receives a supply voltage for powering the LCD driver 11 and driving the LCD matrix 12. Data or information to be displayed on the LCD matrix 12 is received at the data input 18 and the LCD driver 11. The LCD driver 11 uses the segment drive signal output 14 and the backplane drive signal output 16 to drive the LCD matrix 12 and display the data/information received at the data input 18. The LCD driver 11 includes internal circuitry and processing intelligence (not shown) for generating appropriate signals on the segment drive output 14 and the backplane drive output 16 to effect the display of the data on the LCD matrix 12. The data input 18 is typically coupled to a microprocessor or other stored program controlled device, for example, a controller 104 (as shown in FIG. 3) which generates or transmits the data/information to be displayed on the LCD matrix 12.

As shown in FIG. 1, the clock generator circuit 22 is internal to the LCD driver 11. The clock generator circuit 22 generates the internal clocking signals for driving the backplane and segments in the LCD matrix 12. For a multiplexed LCD matrix 12, there is more than one backplane. The LCD driver 11 includes a control port 24 comprising terminals for setting the operating frequency or frequencies for the internal clock generator circuit 22.

As shown in FIG. 1, a compensation circuit indicated by reference 30 is coupled to the control port 24 for the clock generator 22. According to this aspect of the invention, the compensation circuit 30 comprises a resistive component having a resistance variable with temperature, for example a thermistor type device. To compensate for the effects of falling or low temperatures, a negative temperature coefficient (NTC) type thermistor device is selected in accordance with this aspect of the invention.

In operation, as the temperature (i.e. ambient temperature) falls, the resistance of the NTC thermistor 30 increases. The increased resistance applied to the control port 24 causes the clock frequency for the clock generator 22 to drop. The lowered clock frequency results in improved visibility for the LCD matrix 12. As the temperature rises, the resistance of the NTC thermistor 30 decreases and the clock frequency increases. The increasing clock frequency reduces flicker in the LCD matrix 12 which would otherwise be noticeable at temperatures around 25° C. and above. The display flicker for the lowered clock rates (i.e. at low temperatures) is not a significant issue because at low temperature there is a reduction in response speed for the overall circuitry in a level measurement system 100 as shown in FIG. 3 and described in more detail below.

Reference is next made to FIG. 2 which shows another embodiment of a compensation circuit 40 according to the present invention. As shown in FIG. 2, the compensation circuit 40 comprises the thermistor 30 and a bias voltage generator 50. Like reference numerals indicate like elements in FIGS. 1 and 2.

The bias voltage generator 50 has an input 52 for receiving a supply voltage and an output 54 for outputting a compensated supply voltage for powering the LCD driver 11 (i.e. the LCD module 10). As shown, the bias voltage generator 50 also includes a control input 56. The bias voltage generator 50 is responsive a temperature bias signal generated, for example, by a controller 104 (FIG. 3), e.g. a microprocessor operating under stored program control, and the level of the supply voltage output 54 is adjusted. To increase the segment-to-segment contrast ratio on the LCD matrix 12 the supply voltage output 54 is increased as the temperature drops.

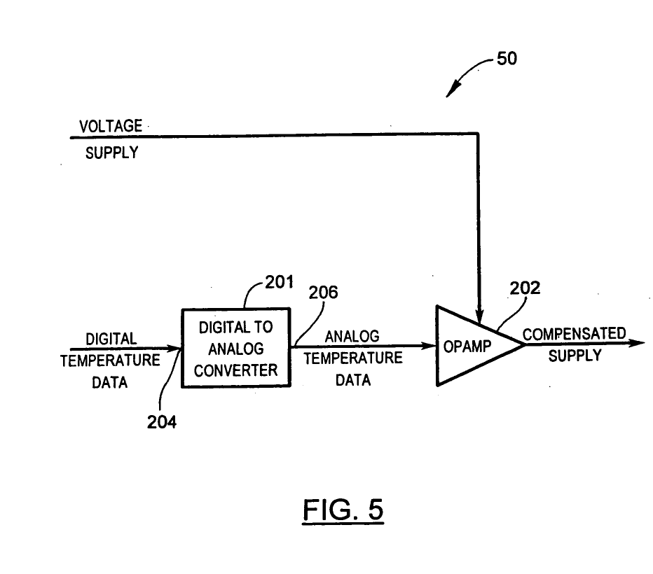

Reference is made to FIG. 5, which shows in schematic form an implementation for the bias generator 50 (FIG. 2). As shown, the bias generator 50 comprises a digital-to-analog (DAC) converter 201 and an operational amplifier circuit 202. The DAC 201 receives at input port 204 a digital temperature data signal, for example from the controller 104 (FIG. 3), and converts the digital temperature signal to an analog temperature data signal at output port 206. The operational amplifier circuit 202 has an input which is coupled to the output port 204 of the DAC 201 and receives the analog temperature data signal. The operational amplifier circuit 202 also receives the supply voltage input, and using the analog temperature data signal, the operational amplifier circuit 202 generates the compensated voltage supply which is applied to the supply voltage input 20 of the LCD driver 11 (FIG. 2). In FIG. 5, the operational amplifier circuit 202 is shown without resistors the inclusion of which is within the understanding of those skilled in the art.

Reference is next made to FIG. 3, which shows a level measurement system or time of flight ranging system 100 with a compensation circuit according to the present invention. The level measurement system 100 comprises a transducer module 102, a controller 104 and a power supply module 106. The level measurement system 100 includes the LCD module 10 and the compensation circuit 30 as described above with reference to FIG. 1. Or as shown in FIG. 4, the level measurement system, indicated generally by reference 101, may include the compensation circuit 40 as described above with reference to FIG. 2. Like reference numerals indicate like elements in FIGS. 3 and 4.

As shown in FIG. 3, the transducer module 102 is coupled to a control port and input/output port on the controller 104. The transducer module 102 includes a transducer 103, a transmitter stage 105 and a receiver stage 107. The transducer 103 may comprise radar-based technology, ultrasonic based technology, TDR-based technology (Time Domain Reflective), or other distance ranging technology. Under the control of a program stored in memory (i.e. firmware), the controller 104 generates a transmit pulse control signal for the transmit stage 105 in the transducer module 102, and the transducer 103 emits a transmit burst of energy, for example, radar pulse(s) directed at the surface of a material contained in a storage vessel (not shown). The reflected or echo pulses, i.e. the propagated transmit pulses reflected by the surface of the material, are coupled by the transducer 103, for example, a radar antenna or other distance ranging technology (not shown), in the transducer module 102 and converted into electrical signals by the receiver stage 107. The electrical signals are inputted by the controller 102 and sampled and digitized by an analog-to-digital (A/D) converter 109 and a receive echo waveform or profile is generated. The controller 104 executes an algorithm which identifies and verifies the echo pulse and calculates the range, i.e. the distance to the reflective surface, from the time it takes for the reflected energy pulse to travel from the reflective surface to the transducer in the transducer module 102. From this calculation, the distance to the surface of the material and thereby the level of the material in the vessel is determined. The controller 104 may comprise a microprocessor or a microcontroller, with on-chip resources, such as an A/D converter, ROM (EPROM), RAM. The microprocessor or microcontroller is suitably programmed to perform these operations as will be within the understanding of those skilled in the art.

In the context of a level measurement device (as described in more detail below), a suitable device for the LCD driver 11 is the Part No. PCF8578 available from Philips Semiconductor. Similarly, a suitable device for the LCD matrix 12 is the 256 segment display with Part No. 92-41596-A01 available from Elec&Eltek.

For the component parts described above, the operating frequency using the arrangement according to the present invention is nominally 12288 Hertz. This gives an internal clock rate of 2048 Hz and a frame rate of 64 Hz. The frame rate is the rate at which the display is refreshed. It will be appreciated that other components may require different operating frequencies and internal clock rates.

Using the arrangement of the present invention, operation over a temperature range of −40° C. to +85° C. is possible. For operation at the lower end of the temperature range, i.e. −40° C., the physical construction of the LCD 12 must be able to tolerate the low temperature. At such low temperatures, the frequency of operation of the main oscillator for the parts described above drops to about 1500 Hz which gives an internal clock rate of about 256 Hz and a frame rate of 8 Hz.

Although the present invention has been described in terms of specific circuit embodiments for level measurement or time of flight ranging systems, the compensation circuit is suitable for LCD modules in other applications where it is desired to compensate for the effects of temperature on the operation and display qualities of the LCD.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A compensation circuit for a liquid crystal display module, said compensation circuit comprising:
(a) a compensation component sensitive to temperature change;
(b) said liquid crystal display module including a clocking circuit, said clocking circuit providing clocking signals for activating segments in said liquid crystal display module, and said clocking circuit having a control input for setting a clocking rate;
(c) said compensation component being coupled to the control input of said liquid crystal display module, and said compensation component varying said clocking rate in response to a change in the temperature.

2. The compensation circuit as claimed in claim 1, wherein said compensation component effectively lowers the clocking rate for said liquid crystal display in response to a drop in the temperature.

3. The compensation circuit as claimed in claim 1 or 2, wherein said compensation component comprises a thermistor.

4. The compensation circuit as claimed in claim 2, wherein said compensation component comprises a negative temperature coefficient thermistor.

5. The compensation circuit as claimed in claim 4, further including a bias voltage component, said bias voltage component having an input for receiving a supply voltage signal and said bias voltage component being responsive to an input control signal to generate a variable output voltage signal, said variable output voltage signal being coupled to a voltage supply input on the liquid crystal display module, so that the voltage supply provided to said liquid crystal display module is variable.

6. The compensation circuit as claimed in claim 5, wherein said bias voltage component comprises a digital-to-analog converter and an operational amplifier circuit, said digital-to-analog having an input port for receiving a digital input signal and an output port for outputting an analog signal, said operational amplifier circuit having an input for receiving said supply voltage signal and another input for receiving the analog signal from said digital-to-analog converter, and said operational amplifier circuit generating the variable output voltage signal based on said analog signal and said supply voltage signal.

7. The compensation circuit as claimed in claim 4, wherein said liquid crystal display module comprises a liquid crystal display matrix and a liquid crystal display driver.

8. A compensation circuit for a liquid crystal display module, said compensation circuit comprising:
(a) a temperature sensitive component, said temperature sensitive component exhibiting an impedance characteristic being variable with changes in temperature;
(b) said liquid crystal display module including a clocking circuit having a control input for setting a clocking rate for said liquid crystal display module;
(c) said temperature sensitive component being connected to said control input for said liquid crystal display module, and a change in temperature causing a variance in the impedance of said temperature sensitive component and said variance in the impedance resulting in a change in said clocking rate;
(d) a bias voltage circuit, said bias voltage circuit having an input for receiving a supply voltage and an output coupled to said liquid crystal display module for providing an operating voltage output to said liquid crystal display module, said bias voltage circuit being responsive to a control signal for varying the operating voltage output in response to a change in the temperature.

9. The compensation circuit as claimed in claim 8, wherein said compensation component effectively lowers the clocking rate for said liquid crystal display in response to a drop in the temperature.

10. The compensation circuit as claimed in claim 8 or 9, wherein said compensation component comprises a thermistor.

11. The compensation circuit as claimed in claim 9, wherein said compensation component comprises a negative temperature coefficient thermistor.

12. The compensation circuit as claimed in claim 11, wherein said liquid crystal display module comprises a liquid crystal display matrix and a liquid crystal display driver.

13. A level measurement system comprising:
(a) a transducer for emitting energy pulses and detecting reflected energy pulses;
(b) a controller having a component for controlling said transducer, and a component for determining a level measurement reading based on the time of flight of said reflected energy pulse;
(c) a liquid crystal display module for displaying said level measurement reading and one or more operating parameters;
(d) a compensation circuit having,
(i) a compensation component sensitive to temperature change;
(ii) said liquid crystal display module including a clocking circuit, said clocking circuit providing clocking signals for actuating segments in said liquid crystal display module, and said clocking circuit having a control input for setting a clocking rate;
(iii) said compensation component being coupled to the control input of said liquid crystal display module, and said compensation component varying said clocking rate in response to a change in the temperature; and
(e) a power supply module having an input for receiving a supply voltage, and an output port for providing power to said level measurement system, and an output for providing power to said liquid crystal display module.

14. The level measurement system as claimed in claim 13, wherein said compensation component effectively lowers the clocking rate for said liquid crystal display in response to a drop in the temperature.

15. The level measurement system as claimed in claim 13 or 14, wherein said compensation component comprises a thermistor.

16. The level measurement system as claimed in claim 14, wherein said compensation component comprises a negative temperature coefficient thermistor.

17. The level measurement system as claimed in claim 16, further including a bias voltage component, said bias voltage component having an input for receiving a supply voltage and said bias voltage component being responsive to an input control signal from said controller to generate a variable output voltage signal, said variable output voltage signal being coupled to the voltage supply input on the liquid crystal display module, so that the voltage supplied to said liquid crystal display module is variable.

18. The compensation circuit as claimed in claim 17, wherein said bias voltage component comprises a digital-to-analog converter and an operational amplifier circuit, said digital-to-analog having an input port for receiving a digital input signal and an output port for outputting an analog signal, said operational amplifier circuit having an input for receiving said supply voltage signal and another input for receiving the analog signal from said digital-to-analog converter, and said operational amplifier circuit generating the variable output voltage signal based on said analog signal and said supply voltage signal.

19. The level measurement system as claimed in claim 16, wherein said liquid crystal display module comprises a liquid crystal display matrix and a liquid crystal display driver.

20. A level measurement system comprising:
(a) a transducer for emitting energy pulses and detecting reflected energy pulses;
(b) a controller for controlling said transducer, said controller being coupled to a transmitter component and said transmitter component being responsive to said controller for generating transmit control signals for said transducer, said controller being coupled to a receiver component and said receiver component generating receive signals for said controller in response to detecting reflected energy pulses by said transducer, and said controller including a component for determining a level measurement reading based on said receiver signals;
(c) a liquid crystal display module for displaying said level measurement reading and one or more operating parameters;
(d) a compensation circuit having,
(i) a compensation component sensitive to temperature change;
(ii) said liquid crystal display module including a clocking circuit, said clocking circuit providing clocking signals for actuating segments in said liquid crystal display module, and said clocking circuit having a control input for setting a clocking rate;
(iii) said compensation component being coupled to the control input of said liquid crystal display module, and said compensation component varying said clocking rate in response to a change in the temperature; and
(e) a power supply module having an input for receiving a supply voltage, and an output port for providing power to said level measurement system, and an output for providing power to said liquid crystal display module.

21. The level measurement system as claimed in claim 20, wherein said compensation component effectively lowers the clocking rate for said liquid crystal display in response to a drop in the temperature.

22. The level measurement system as claimed in claim 21, wherein said compensation component comprises a negative temperature coefficient thermistor.

23. The level measurement system as claimed in claim 22, further including a bias voltage component, said bias voltage component having an input for receiving a supply voltage and said bias voltage component being responsive to an input control signal from said controller to generate a variable output voltage signal, said variable output voltage signal being coupled to the voltage supply input on the liquid crystal display module, so that the voltage supplied to said liquid crystal display module is variable.
